(19) United States
(12) Patent Application Publication
(10) Pub. No.: US 2025/0276732 A1
(43) Pub. Date: Sep. 4, 2025

(54) WORK VEHICLE

(71) Applicant: Kubota Corporation, Osaka (JP)

(72) Inventors: Yusuke IDA, Sakai-shi (JP); Minoru HIRAOKA, Sakai-shi (JP); Yukifumi YAMANAKA, Sakai-shi (JP); Junichi ISHIKAWA, Sakai-shi (JP); Kaichiro YOSHII, Sakai-shi (JP); Yuhei HAZAWA, Sakai-shi (JP); Katsutoshi JINNOUCHI, Sakai-shi (JP); Ryota NIKI, Sakai-shi (JP); Ryota YAMAGISHI, Sakai-shi (JP)

(21) Appl. No.: 19/210,046

(22) Filed: May 16, 2025

Related U.S. Application Data
(63) Continuation of application No. PCT/JP2023/038132, filed on Oct. 23, 2023.

(30) Foreign Application Priority Data
Nov. 29, 2022 (JP) 2022-190266
Nov. 29, 2022 (JP) 2022-190268

(51) Int. Cl. B62D 7/15; B62B 5/00; B62B 5/04

(52) U.S. Cl. CPC B62D 7/159; B62B 5/0466; B62D 7/1509; B62B 5/0026

(57) ABSTRACT

A work vehicle includes a vehicle body including a loading portion that is able to load a load, drive wheels located in front and rear on both right and left sides of the vehicle body and steerable separately, a steering angle detector to detect respective orientations of the drive wheels, and a controller configured or programmed to perform drive control to drive each of the drive wheels and control to change the respective orientations of the drive wheels separately. The controller is configured or programmed such that the respective orientations of a first of the drive wheels located on one of right and left sides of the vehicle body and a second of the drive wheels located on the other of the right and left sides of the vehicle body are different from each other when the drive control is stopped.

### CROSS REFERENCE TO RELATED APPLICATIONS

This application claims the benefit of priority to Japanese Patent Application Nos. 2022-190266 and 2022-190268 filed on Nov. 29, 2022 and is a Continuation Application of PCT Application No. PCT/JP2023/038132 filed on Oct. 23, 2023. The entire contents of each application are hereby incorporated herein by reference.

### BACKGROUND OF THE INVENTION

### 1. Field of the Invention

The present invention relates to work vehicles.

### 2. Description of the Related Art

For example, as a work vehicle in the related art disclosed in Japanese Patent Application Laid-Open No. 2020-1443 and Japanese Patent Application Laid-Open No. 2019-111985, a work vehicle that is able to travel on an irregular land (a portion having a step or unevenness) is known. These work vehicles include a vehicle body, a plurality of drive wheels for causing the vehicle body to travel, a plurality of auxiliary wheels for assisting traveling of the vehicle body, and a plurality of support legs connected to the vehicle body to support the drive wheels and the auxiliary wheels. The drive wheels are drive-controlled by a controller. The drive wheels are configured to be steered separately by a turning mechanism.

### SUMMARY OF THE INVENTION

By the way, it is important that a stop position of the work vehicle is maintained when the work vehicle is stopped. Therefore, a configuration in which the drive wheel includes a brake mechanism is common. However, for example, in a case where the work vehicle is stopped for a long period of time, it is conceivable that a braking force of a brake decreases with the passage of time and the stop position of the work vehicle is not maintained for a long period of time. Therefore, for example, when the work vehicle is stopped on an inclined land for a long period of time, it is conceivable that there is a possibility that the work vehicle gradually goes down the inclined land with the passage of time. As a measure for avoiding such inconvenience, it is conceivable that a mechanical type parking brake is mounted on the work vehicle. However, when such a parking brake is mounted, the number of components increases, which increases the cost.

Accordingly, an example embodiment of the present invention provides a work vehicle that is able to maintain the stop position of the work vehicle for a long period of time with a simple configuration. In addition, in such a work vehicle, it is desired to more suitably travel on an irregular land. In view of this situation, an example embodiment of the present invention provides a work vehicle that is able to more suitably travel on the irregular land.

A work vehicle according to an example embodiment of the present invention includes a vehicle body including a loading portion that is able to load a load, a plurality of drive wheels located in front and rear on both right and left sides of the vehicle body and configured to be steered separately, a steering angle detector to detect respective orientations of the plurality of drive wheels, and a controller configured or programmed to perform drive control to drive each of the plurality of drive wheels and control to change the respective orientations of the plurality of drive wheels separately, in which the controller is configured or programmed such that the respective orientations of a first drive wheel located on one of right and left sides of the vehicle body among the plurality of drive wheels and a second drive wheel located on the other of the right and left sides of the vehicle body among the plurality of drive wheels are different from each other when the drive control is stopped.

According to an example embodiment of the present invention, the controller is configured or programmed such that the respective orientations of the first drive wheel located on one of right and left drive wheels and the second drive wheel located on the other of the right and left drive wheels are different from each other. When the respective orientations of the right and left drive wheels are different from each other, a rolling orientation of one of the right and left drive wheels and a rolling orientation of the other of the right and left drive wheels are different from each other. From this, each of the right and left drive wheels interacts with a force with each other in directions different from the rotation directions, and receives a reaction force in a lateral skidding direction from the ground. That is, when the drive wheel is about to roll, friction occurs between the drive wheel and the ground. As a result, each of the right and left drive wheels does not rotate. Accordingly, for example, even in a case where the work vehicle is stopped for a long period of time on an inclined land, the stop position of the work vehicle is maintained without requiring a dedicated parking brake. As a result, a work vehicle that is able to maintain the stop position of the work vehicle for a long period of time with a simple configuration is realized.

Further, in an example embodiment of the present invention, the controller is preferably configured or programmed such that the respective orientations of the first drive wheel and the second drive wheel are different from each other to make the respective orientations opposite to each other with respect to the neutral orientation in which the vehicle body is caused to move straight or substantially straight when the drive control is stopped.

According to the present example configuration, the right and left drive wheels interact forces with each other in opposite orientations with respect to the straight movement direction of the vehicle body. As a result, each of the right and left drive wheels receives a reaction force in the lateral skidding direction from the ground and does not rotate.

Further, in an example embodiment of the present invention, the controller is preferably configured or programmed such that the orientations of all the plurality of drive wheels are different from each other when the drive control is stopped.

According to the present example configuration, the stop position of the work vehicle is reliably maintained each time the controller stops the drive control. In addition, friction is strongly generated between the drive wheels and the ground due to the configuration in which all the orientations of the plurality of drive wheels are different from each other. Accordingly, the stop position of the work vehicle is firmly maintained.

Further, in an example embodiment of the present invention, the work vehicle preferably further includes an inclination detector to detect an inclination state of the vehicle body, in which the controller is preferably configured or programmed such that the respective orientations of the first drive wheel located on a lower side in one of the right and left sides among the plurality of drive wheels and the second drive wheel located on a lower side on the other of the right and left sides among the plurality of drive wheels are different from each other based on the inclination state of the vehicle body.

According to the present configuration, since each of the first drive wheel and the second drive wheel is located on the lower side, each of the first drive wheel and the second drive wheel firmly receives a weight of the vehicle body. Therefore, the frictional force between the drive wheel and the ground is increased, and the stop position of the work vehicle is firmly maintained.

Further, in an example embodiment of the present invention, the work vehicle preferably further includes an operation detector to detect a manual operation with respect to the plurality of drive wheels, in which the controller is preferably configured or programmed such that the respective orientations of the first drive wheel and the second drive wheel are different from each other when a preset time elapses from a time when the operation detector detects no manual operation.

According to the present example configuration, the stop position of the work vehicle is reliably maintained each time the operation detector does not detect the manual operation.

In an example embodiment of the present invention, the work vehicle preferably further includes a support supported by the vehicle body to support the plurality of drive wheels to be positionally changeable with respect to the vehicle body, a hydraulic motor to drive each of the plurality of drive wheels by using supply and discharge of hydraulic fluid as drive energy, a control valve to change supply and discharge amounts of the hydraulic fluid with respect to the hydraulic motor, and an inclination detector to detect an inclination state of the loading portion, in which the controller is preferably configured or programmed to control an operation of the support mechanism such that the loading portion is in a horizontal posture based on the inclination state of the loading portion, and such that the drive control is stopped by closing the control valve to block the supply and discharge of the hydraulic fluid with respect to the hydraulic motor when the vehicle is stopped.

According to an example embodiment of the present configuration, the loading portion is maintained in the horizontal posture based on the operation of the support mechanism. In addition, the plurality of drive wheels use hydraulic pressure as a drive source. Therefore, when the supply and discharge of the hydraulic fluid with respect to the hydraulic motor is blocked, the drive wheel is stopped, and when the hydraulic fluid inside the hydraulic motor does not flow, the rotation of the hydraulic motor is locked. In this case, the hydraulic motor functions as a brake with respect to the drive wheel. However, there is a case where the hydraulic fluid leaks from the hydraulic motor, and in this case, the hydraulic motor does not function as a brake. Even in such a case, the stop position of the work vehicle is firmly maintained by the configuration in which the respective orientations of the first drive wheel and the second drive wheel are different from each other.

Another example embodiment of the present invention provides a work vehicle including a vehicle body, a plurality of drive wheels to cause the vehicle body to travel, a plurality of auxiliary wheels to assist traveling of the vehicle body, and a plurality of support legs connected to the vehicle body to support the drive wheels and the auxiliary wheels, in which lugs are provided on a tread portion of the drive wheel, and a tread portion of the auxiliary wheel has a different shape than that of the tread portion of the drive wheel.

According to an example embodiment of the present invention, since the lugs are provided in the tread portion of the drive wheel, the drive wheel is able to exert a grip force. In addition, because the tread portion of the auxiliary wheel has a shape different from the tread portion of the drive wheel, the auxiliary wheel easily exerts an original function of assisting the vehicle body in traveling. That is, according to the present example configuration, it is possible to realize a work vehicle that is able to more suitably travel on an irregular land.

Further, in an example embodiment of the present invention, the lugs are preferably provided only on the tread portion of the drive wheel in the tread portion of the drive wheel and the tread portion of the auxiliary wheel.

Here, since the auxiliary wheel is not rotationally driven, the auxiliary wheel rotates following the drive wheel that is rotationally driven. According to the present example configuration, since the lugs are not provided on the tread portion of the auxiliary wheel, it is difficult to impair the original function of assisting the traveling of the vehicle body with the auxiliary wheel. For example, the auxiliary wheel is less likely to exert an unnecessary grip force or be caught on surrounding objects. Accordingly, the work vehicle is able to be caused to smoothly travel.

Further, in an example embodiment of the present invention, the lugs are preferably provided on the tread portion of the drive wheel and the tread portion of the auxiliary wheel, respectively, and a height of the lug of the auxiliary wheel is preferably lower than a height of the lug of the drive wheel.

According to the present configuration, since the height of the lug of the auxiliary wheel is lower than the height of the lug of the drive wheel, it is difficult to impair the original function of assisting the traveling of the vehicle body with the auxiliary wheels. For example, the auxiliary wheel is less likely to exert an unnecessary grip force or be caught on surrounding objects.

Further, in an example embodiment of the present invention, the plurality of drive wheels preferably includes the drive wheels on a front side and the drive wheels on a rear side, and the lugs in the drive wheels on the front side and the lugs in the drive wheels on the rear side are preferably arranged front-rear symmetrically.

According to the present example configuration, when the work vehicle moves forward, the lugs in the drive wheels on the front side are arranged such that the drive wheels on the front side exert the grip force, and when the work vehicle moves backward, the lugs in the drive wheels on the rear side are arranged such that the drive wheels on the rear side exert the grip force.

Further, in an example embodiment of the present invention, an outer diameter of the auxiliary wheel is preferably smaller than an outer diameter of the drive wheel.

According to the present example configuration, the diameter of the auxiliary wheel is reduced, and thus the distance (wheel base) between the center of the drive wheels on the front side and the center of the drive wheels on the rear side is able to be shortened.

Further, in an example embodiment of the present invention, the work vehicle preferably further includes a plurality of mudguards to cover each of the plurality of drive wheels from above, in which the mudguards extend along an outer peripheral shape of the drive wheels.

According to the present example configuration, the mudguards extend along the outer peripheral shapes of the drive wheels, and the mudguards are able to be compact while preventing the mud splashed by the drive wheel from being attached to the vehicle body or the like.

Furthermore, in an example embodiment of the present invention, the mudguards are preferably above rotation axis centers of the drive wheels.

According to the present configuration, since the mudguards are located at relatively high positions, the mudguards are able to be prevented from coming into contact with the ground.

Further, in an example embodiment of the present invention, the drive wheel is preferably operable to steer, and the mudguards are preferably supported by the support legs.

According to the present example configuration, the support legs support the mudguards. In addition, the mudguards are able to be integrated with the support leg and thus the mudguards do not hinder the steering operation of the drive wheel.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view of a work vehicle according to a first example embodiment of the present invention.

FIG. 2 is a rear view of the work vehicle according to the first example embodiment of the present invention.

FIG. 3 is a plan view of the work vehicle according to the first example embodiment of the present invention.

FIG. 4 is a plan view of a support mechanism according to the first example embodiment of the present invention.

FIG. 5 is a side view of the support mechanism according to the first example embodiment of the present invention.

FIG. 6 is a control block diagram according to the first example embodiment of the present invention.

FIG. 7 is a plan view of the work vehicle while orientations of drive wheels are different from each other in the first example embodiment of the present invention.

FIG. 8 is a flowchart illustrating control when a vehicle is stopped in the first example embodiment of the present invention.

FIG. 9 is a left side view illustrating a work vehicle according to a second example embodiment of the present invention.

FIG. 10 is a plan view illustrating the work vehicle according to the second example embodiment of the present invention.

FIG. 11 is a left side view illustrating a drive wheel on a left front side, a drive wheel on a left rear side, an auxiliary wheel on a left front side, an auxiliary wheel on a left rear side, a mudguard on a left front side, and a mudguard on a left rear side according to the second example embodiment of the present invention.

FIG. 12 is a plan view illustrating the drive wheel on the left front side, the drive wheel on the left rear side, the auxiliary wheel on the left front side, the auxiliary wheel on the left rear side, the mudguard on the left front side, and the mudguard on the left rear side according to the second example embodiment of the present invention.

FIG. 13 is a left side view illustrating the work vehicle that moves forward on an uphill slope in the second example embodiment of the present invention.

FIG. 14 is a left side view illustrating the work vehicle that moves backward on a downhill slope in the second example embodiment of the present invention.

FIG. 15 is a left side view illustrating a drive wheel on a left front side, a drive wheel on a left rear side, an auxiliary wheel on a left front side, an auxiliary wheel on a left rear side, a mudguard on a left front side, and a mudguard on a left rear side according to another example embodiment of the second example embodiment of the present invention.

FIG. 16 is a plan view illustrating the drive wheel on the left front side, the drive wheel on the left rear side, the auxiliary wheel on the left front side, the auxiliary wheel on the left rear side, the mudguard on the left front side, and the mudguard on the left rear side according to another example embodiment of the second example embodiment of the present invention.

### DETAILED DESCRIPTION OF THE EXAMPLE EMBODIMENTS

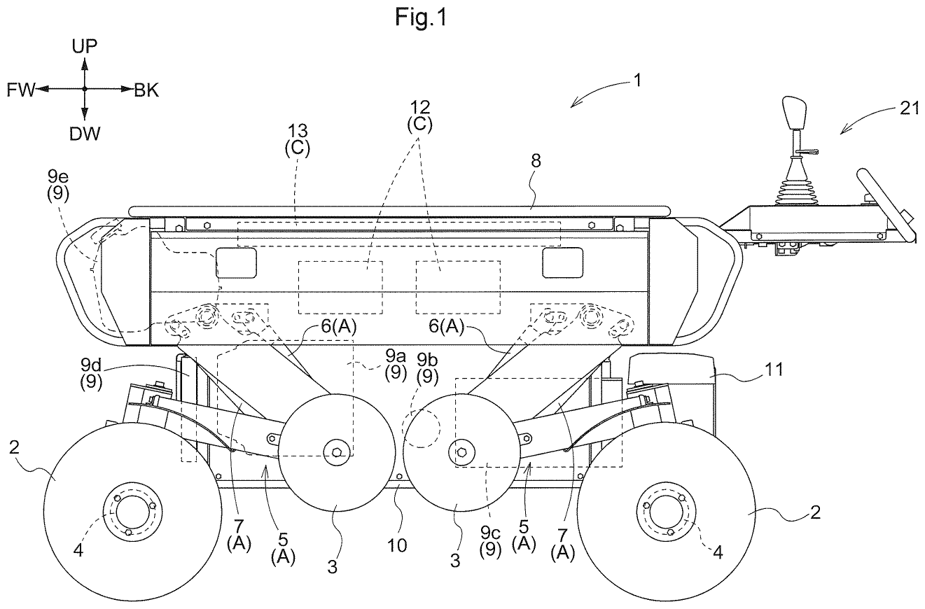

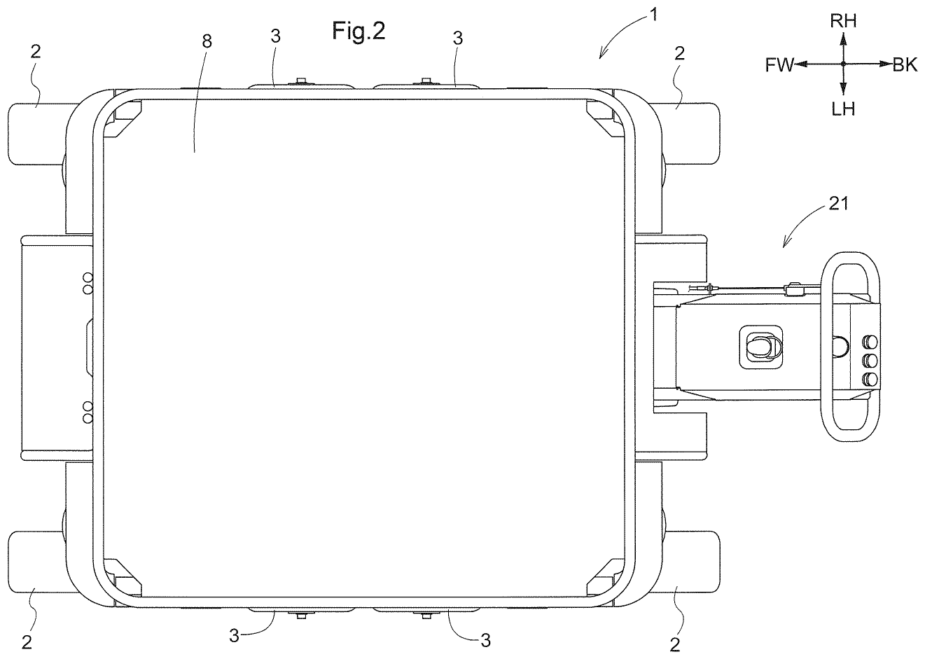

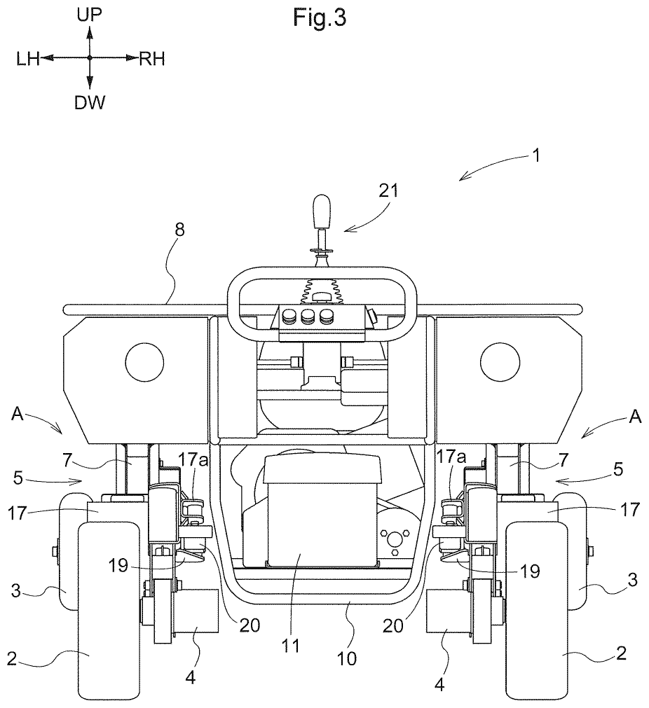

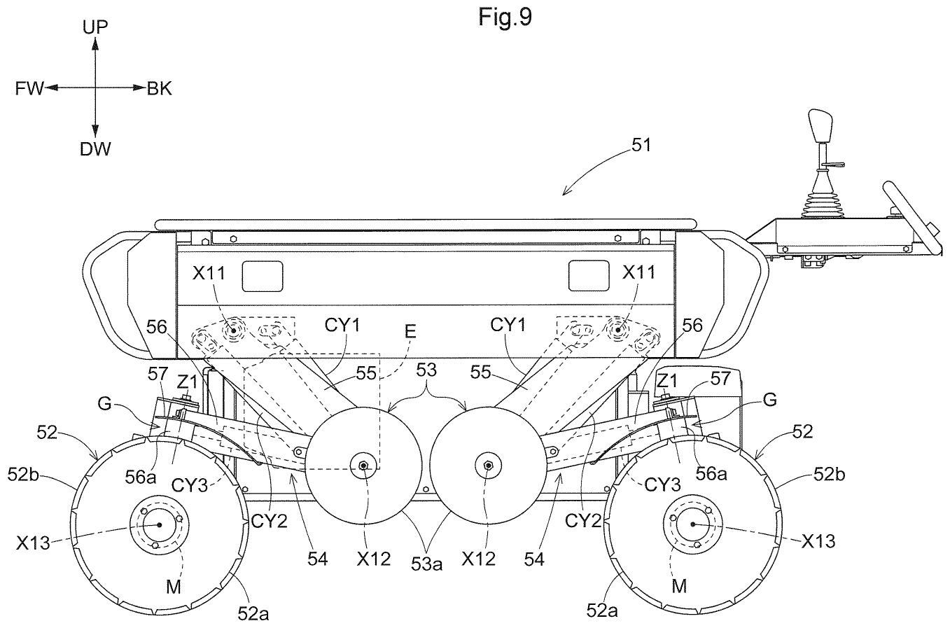

A first example embodiment of the present invention will be described with reference to FIGS. 1 to 8, and a second example embodiment of the present invention will be described with reference to FIGS. 9 to 16. A direction of an arrow “FW” illustrated in the drawing is defined as “front of a vehicle body”, a direction of an arrow “BK” illustrated in the drawing is defined as “rear of the vehicle body”, a direction of an arrow “LH” illustrated in the drawing is defined as “left of the vehicle body”, a direction of an arrow “RH” illustrated in the drawing is defined as “right of the vehicle body”, a direction of an arrow “UP” illustrated in the drawing is defined as “top of the vehicle body”, and a direction of an arrow “DW” illustrated in the drawing is defined as “bottom of the vehicle body”.

### First Example Embodiment

As illustrated in FIGS. 1 to 3, a work vehicle includes a vehicle body 1 (vehicle main body) having a substantially rectangular shape in a plan view, four drive wheels 2 (traveling wheels), four auxiliary wheels 3, support mechanisms A, and four hydraulic motors 4. The vehicle body 1 supports equipment and the like of the entire vehicle. The four drive wheels 2 support the vehicle body 1. The four auxiliary wheels 3 are provided corresponding to the four drive wheels 2, respectively. The support mechanisms A support the four drive wheels 2 to be positionally changeable with respect to the vehicle body 1. The hydraulic motor 4 drives the drive wheel 2. The hydraulic motor 4 receives drive energy by the supply and discharge of a hydraulic fluid. The four drive wheels 2 are driven independently by the four hydraulic motors 4. The drive wheel 2 located on one of the right and left sides corresponds to a “first drive wheel”. The drive wheel 2 located on one of the right and left sides corresponds to a “second drive wheel”.

The drive wheels 2 are each located in front and rear on both right and left sides of the vehicle body 1. In the first example embodiment, the work vehicle includes the four drive wheels 2 of a left front, a right front, a left rear, and a right rear. In addition, the work vehicle includes the support mechanisms A that support the four drive wheels 2. The support mechanism A includes four folding link mechanisms 5 (support legs), four first hydraulic cylinders 6, and four second hydraulic cylinders 7. Each of the four first hydraulic cylinders 6 and the four second hydraulic cylinders 7 is a telescopic actuator to change the position of the drive wheel 2 with respect to the vehicle body 1, and is configured to individually change a posture of the folding link mechanism 5.

An upper surface of the vehicle body 1 includes a flat loading portion 8 on which a load is able to be loaded. The loading portion 8 is a portion having a substantially rectangular shape in a plan view and extends from a right end to a left end of the vehicle body 1. The load is able to be placed on the loading portion 8. The load placed on the loading portion 8 is, for example, agricultural materials, agricultural materials such as fertilizers and chemicals, harvested products or harvest baskets, and pallets on which these are placed.

A hydraulic supply source 9, a plurality of hydraulic control valves 12, an electronic control unit (ECU) 13, a battery 11 for power supply, and the like are provided below the loading portion 8 in the vehicle body 1. The hydraulic supply source 9 sends out the hydraulic fluid toward the first hydraulic cylinder 6, the second hydraulic cylinder 7, and the hydraulic motor 4. From this, the hydraulic supply source 9 is configured to supply the drive energy to operate the support mechanism A and the drive energy for driving the four drive wheels 2. The plurality of hydraulic control valves 12 adjusts a supply state of the hydraulic fluid from the hydraulic supply source 9. The hydraulic control valve 12 may be a proportional valve or may be an electromagnetic valve of a PWM control method. The ECU 13 is configured or programmed to control an operation of the hydraulic control valve 12. The hydraulic control valve 12 corresponds to a “control valve”.

The hydraulic supply source 9 is supported by an underframe 10. The hydraulic supply source 9 includes an engine 9a, a hydraulic pump 9b, a hydraulic fluid tank 9c, a radiator 9d, a fuel tank 9e, and the like. The hydraulic pump 9b is driven by the engine 9a. The fuel tank 9e is located at a rear portion of the vehicle body 1.

The ECU 13 includes a microcomputer and is able to execute various controls in accordance with a control program. In the first example embodiment, a controller C is configured or programmed of a plurality of hydraulic control valves 12 and the ECU 13. A generator (not illustrated) is driven by the power of the engine 9a. Then, the power generated by the generator is charged in the battery 11.

A drive operation interface 21 is provided behind the loading portion 8 in the vehicle body 1. The drive operation interface 21 is able to perform a manual operation by an operator from the outside of the vehicle. The operator is able to perform the drive operation of the vehicle with an operation of the drive operation interface 21. In addition, the operator is able to perform the drive operation of the vehicle with a remote operation of a remote control device RC as a wireless operation method in addition to the operation of the drive operation interface 21. The remote control device RC is, for example, a proportional type wireless transmitter, a smartphone, or a tablet computer. Each of the drive operation interface 21 and the remote control device RC is configured to output a signal of a traveling command or a signal of a turning command for the drive wheel 2, a signal of a lifting/lowering command for the folding link mechanism 5, and the like, based on a manual operation of the operator.

As described above, the support mechanism A includes a plurality of (for example, four in the first example embodiment) folding link mechanisms 5, a plurality of (for example, four in the first example embodiment) first hydraulic cylinders 6, and a plurality of (for example, four in the first example embodiment) second hydraulic cylinders 7. As illustrated in FIG. 1, the four drive wheels 2 are supported separately from each other with respect to the vehicle body 1 via the folding link mechanisms 5 to be liftable and lowerable. In other words, the support mechanisms A are supported by the vehicle body 1 and support the four drive wheels 2 to be positionally changeable with respect to the vehicle body 1.

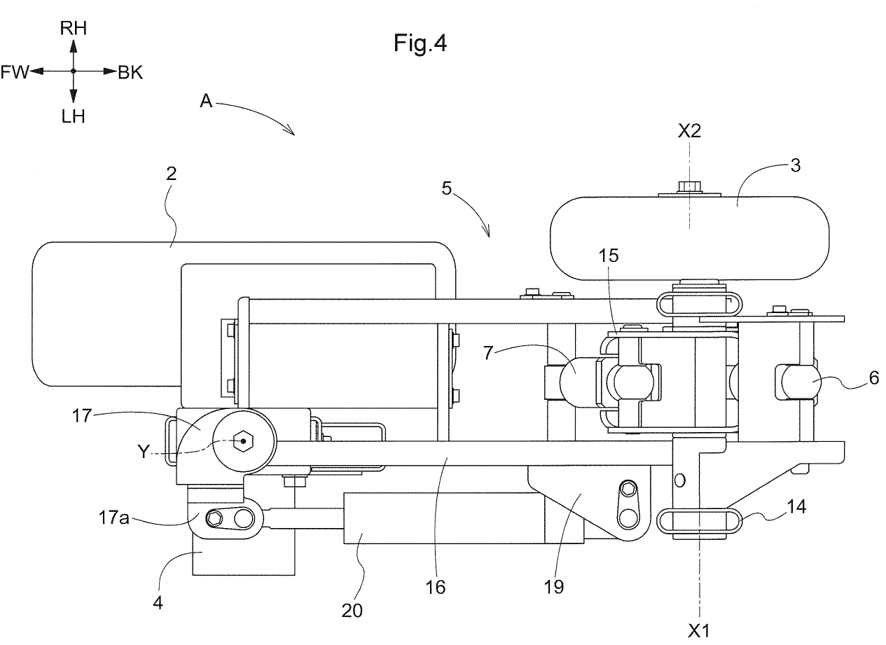

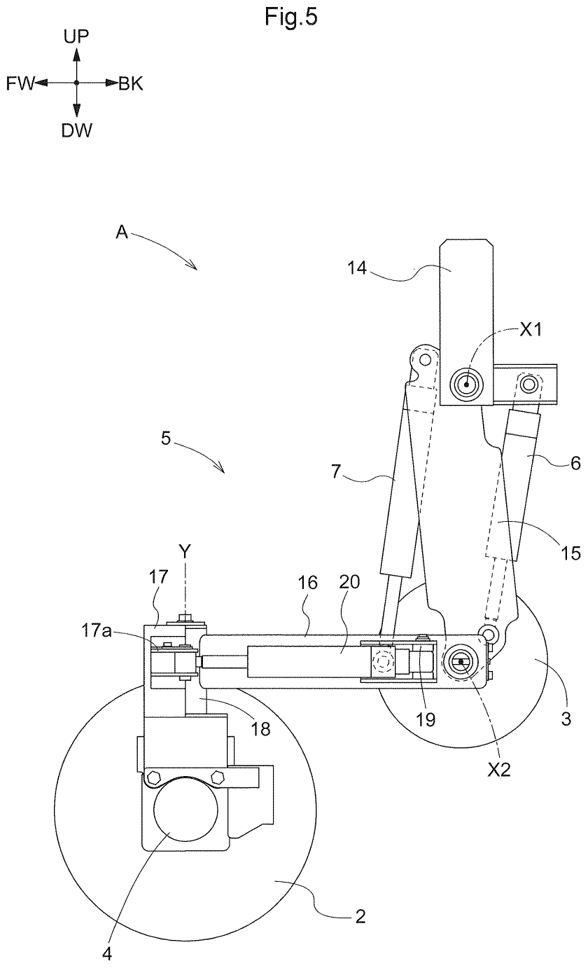

As illustrated in FIGS. 4 and 5, the folding link mechanism 5 includes a proximal end portion 14, a first link 15, and a second link 16. The proximal end portion 14 is supported by the vehicle body 1. An upper end portion of the first link 15 is rotatably supported by a lower portion of the proximal end portion 14 around a horizontal axis center X1. One end portion of the second link 16 is rotatably supported by a lower end portion of the first link 15 around a horizontal axis center X2. In addition, a support bracket 17 is connected to the other end portion of the second link 16. The drive wheel 2 is supported by the support bracket 17.

A boss portion 18 is provided at a swing-side end portion of the second link 16. The support bracket 17 is supported by the boss portion 18 to be swingable around a vertical axis center Y. One end portion of the second link 16 includes a bracket 19. The support bracket 17 includes an arm portion 17a. A hydraulic drive type turning cylinder 20 is provided between the bracket 19 and the arm portion 17a.

The first hydraulic cylinder 6, the second hydraulic cylinder 7, and the turning cylinder 20 are driven to be extended and/or contracted by the hydraulic fluid from the hydraulic pump 9b.

The first hydraulic cylinder 6 is configured to change a swing posture of the first link 15 with respect to the vehicle body 1. In addition, the second hydraulic cylinder 7 is configured to change the swing posture of the second link 16 with respect to the first link 15.

While the operation of the second hydraulic cylinder 7 is stopped, when the first hydraulic cylinder 6 extends or contracts, each of the first link 15, the second link 16, and the drive wheel 2 integrally swings around the horizontal axis center X1 while a relative posture is constantly maintained. While the operation of the first hydraulic cylinder 6 is stopped, when the second hydraulic cylinder 7 extends or contracts, the second link 16 and the drive wheel 2 integrally swing around the horizontal axis center X2 while the posture of the first link 15 is constantly maintained.

The auxiliary wheel 3 is rotatably supported at an intermediate folding portion of each of the plurality of folding link mechanisms 5. The auxiliary wheel 3 is a wheel having an outer diameter that is the same or substantially the same as that of the drive wheel 2. The first link 15 and the second link 16 are pivotally connected to each other by a support shaft. The support shaft protrudes to the outer side in a lateral width direction of the vehicle body. The auxiliary wheel 3 is rotatably supported at a protruding portion of the support shaft.

An orientation of the drive wheel 2 is changed by the extension and contraction of the turning cylinder 20. In other words, the drive wheel 2 is turning-driven by the extension and contraction operation of the turning cylinder 20. The turning cylinder 20 is located on a right and left center side of the vehicle body 1 with respect to the drive wheel 2 of a turning target. When the turning cylinder 20 extends or contracts, the drive wheel 2 rotates around the vertical axis center Y with respect to the folding link mechanism 5. Accordingly, the turning operation of the drive wheel 2 is possible.

The drive wheel 2 located below the front right portion of the vehicle body 1 is turned clockwise by the extension of the turning cylinder 20 and is turned counterclockwise by the contraction of the turning cylinder 20. The drive wheel 2 located below the front left portion of the vehicle body 1 is turned counterclockwise by the extension of the turning cylinder 20 and is turned clockwise by the contraction of the turning cylinder 20. The drive wheel 2 located below the rear right portion of the vehicle body 1 is turned counterclockwise by the extension of the turning cylinder 20 and is turned clockwise by the contraction of the turning cylinder 20. The drive wheel 2 located below the rear left portion of the vehicle body 1 is turned clockwise by the extension of the turning cylinder 20 and is turned counterclockwise by the contraction of the turning cylinder 20. When the vehicle body 1 moves straight or substantially straight, each stroke position of the four turning cylinders 20 is located at a neutral stroke position set in advance between a stroke end on an extension side and a stroke end on a contraction side.

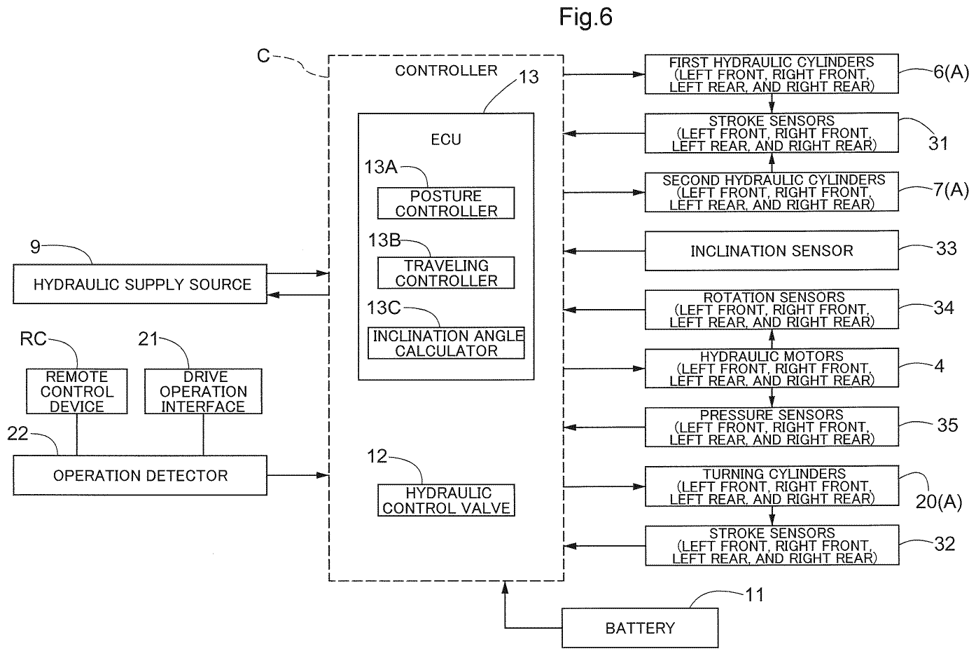

A control configuration of the first example embodiment will be described with reference to FIG. 6. The ECU 13 is configured or programmed to control a flow rate adjustment of the hydraulic fluid in the hydraulic control valve 12. The hydraulic control valve 12 is configured to adjust the supply and discharge amounts of the hydraulic fluid in each of the four hydraulic motors 4, the four first hydraulic cylinders 6, the four second hydraulic cylinders 7, and the four turning cylinders 20. As a result, the ECU 13 is able to control a rotation speed of the hydraulic motor 4, that is, a rotation speed of the drive wheel 2.

This work vehicle includes various sensors. Each of the four first hydraulic cylinders 6 and the four second hydraulic cylinders 7 includes a stroke sensor 31. In addition, each of the four turning cylinders 20 includes a stroke sensor 32 that is able to detect the stroke position. An inclination sensor 33 that is able to detect an inclination state of the vehicle body 1 is provided. Further, a rotation sensor 34 that is able to detect the rotation speed of the drive wheel 2 is provided in the vicinity of the drive wheel 2. In addition, the hydraulic motor 4 includes a pressure sensor 35 that is able to detect a pressure of the hydraulic fluid. The stroke sensor 32 corresponds to a “steering angle detector”.

The stroke sensor 31 is able to detect the stroke position of each of the four first hydraulic cylinders 6 and the four second hydraulic cylinders 7. The stroke position of the first hydraulic cylinder 6 is a detection value corresponding to a swing position of the first link 15. The stroke position of the second hydraulic cylinder 7 is a detection value corresponding to a swing position of the second link 16. In other words, the stroke sensor 31 detects the extension and contraction amounts of each of the first hydraulic cylinder 6 and the second hydraulic cylinder 7.

The inclination sensor 33 includes an inertial measurement unit (IMU) having a well-known configuration. The IMU includes a three-axis acceleration sensor and a gyro sensor, and is able to detect a posture change state of the vehicle body 1, specifically, an inclination in the front-rear direction and the right-left direction. The inclination sensor 33 is configured to detect an inclination state of the loading portion 8. The inclination sensor 33 corresponds to an “inclination detector”.

The ECU 13 is connected to the operation detector 22. The operation detector 22 receives each of a signal from the drive operation interface 21 and a wireless signal from the remote control device RC of the wireless communication method. The operation detector 22 is configured to detect a manual operation with respect to the four drive wheels 2 and the folding link mechanisms 5.

The ECU 13 includes a non-volatile memory (not illustrated) that stores a program corresponding to a functional unit described below, and a CPU (not illustrated) that executes the program. Functions of each functional unit are realized by executing the program by the CPU. The ECU 13 is configured or programmed to include, as functional units, a posture controller 13A, a traveling controller 13B, an inclination angle calculator 13C, and the like.

The inclination angle calculator 13C calculates an inclination angle of the ground on which each of the four drive wheels 2 is grounded, based on detection information of the inclination sensor 33, the stroke positions of each of the four first hydraulic cylinders 6, and the stroke positions of the four second hydraulic cylinders 7. That is, the controller C is configured or programmed to calculate the inclination angle of the ground on which the four drive wheels 2 are grounded. The inclination angle calculator 13C corresponds to an “inclination detector”.

The posture controller 13A is configured or programmed to discriminate the swing posture of the first link 15 with respect to the vehicle body 1, the swing posture of the second link 16 with respect to the first link 15, and the like based on the detection value of the stroke sensor 31. As a result, it is possible to calculate a height from a ground portion of the drive wheel 2 to the vehicle body 1. When the vehicle body is moved and travels, the posture controller 13A is configured or programmed to execute horizontal control of controlling the operation of the support mechanism A such that the loading portion 8 of the vehicle body 1 is in a horizontal posture based on the detection information of the inclination sensor 33. In the horizontal control, the posture controller 13A is configured or programmed to control the operations of the four first hydraulic cylinders 6 and the four second hydraulic cylinders 7 such that the inclination angle in the front-rear direction and the inclination angle in the right-left direction from the horizontal posture of the vehicle body 1 is a value corresponding to the horizontal posture, based on the detection information of the inclination sensor 33 and the detection information of the stroke sensor 31. As described above, the posture controller 13A of the controller C is configured or programmed to control the operation of each of the first hydraulic cylinder 6 and the second hydraulic cylinder 7 in the support mechanism A such that the loading portion 8 is in the horizontal posture, based on the inclination state of the vehicle body 1 (loading portion 8) and the extension and contraction amounts of each of the first hydraulic cylinder 6 and the second hydraulic cylinder 7.

The traveling controller 13B is configured or programmed to control the supply and discharge of the hydraulic fluid of the hydraulic motor 4 such that the rotation speed of the drive wheel 2 is a target value, based on the rotation speed of the drive wheel 2 detected by the rotation sensor 34. In addition, the traveling controller 13B is configured or programmed to control the supply (pressure) of the hydraulic fluid to the hydraulic motor 4 such that a drive torque of the drive wheel 2 has a target value, based on the pressure of the hydraulic fluid detected by the pressure sensor 35. The hydraulic control valve 12 is able to change the supply and discharge amounts of the hydraulic fluid with respect to the hydraulic motor 4. The traveling controller 13B executes a switching operation of the hydraulic control valve 12 that supplies and discharges the hydraulic fluid with respect to the hydraulic motor 4.

In addition, the traveling controller 13B is configured or programmed to change the orientation of the drive wheel 2 based on the detection value of the stroke sensor 32. Specifically, the traveling controller 13B executes the switching operation of the hydraulic control valve 12 that supplies and discharges the hydraulic fluid with respect to the turning cylinder 20. The traveling controller 13B is configured or programmed to perform control of changing each orientation of the four drive wheels 2 separately.

When the vehicle body 1 is stopped, the traveling controller 13B is configured or programmed to perform control of causing the hydraulic control valve 12 to block the supply and discharge of the hydraulic fluid with respect to the hydraulic motor 4. When the supply and discharge of the hydraulic fluid with respect to the hydraulic motor 4 is blocked, the hydraulic motor 4 is stopped. In this case, the hydraulic fluid inside the hydraulic motor 4 does not flow. Therefore, the hydraulic motor 4 cannot rotate, and the rotation of each of the four drive wheels 2 is stopped. That is, the traveling controller 13B of the controller C does not supply the drive energy to the four hydraulic motors 4 and thus the four drive wheels 2 while the four drive wheels 2 are stopped. Since the hydraulic control valve 12 is blocked, the hydraulic fluid inside the hydraulic motor 4 cannot enter or exit. As a result, each of the four drive wheels 2 is locked by the hydraulic fluid inside the hydraulic motor 4, and the vehicle body 1 is able to maintain the stopped state. As described above, the traveling controller 13B of the controller C is configured or programmed such that the drive control of the hydraulic motor 4 is stopped by closing the hydraulic control valve 12 when the vehicle is stopped and blocking the supply and discharge of the hydraulic fluid with respect to the hydraulic motor 4.

However, the hydraulic fluid inside the hydraulic motor 4 may leak little by little from the hydraulic control valve 12 with the passage of time. In this case, each of the four drive wheels 2 cannot maintain the locked state with the hydraulic fluid inside the hydraulic motor 4. In particular, in the inclined land, when the hydraulic fluid inside the hydraulic motor 4 leaks, there is a concern that each of the four drive wheels 2 gradually rotates due to a self-weight of the work vehicle, and the stop position of the vehicle body 1 is not maintained. In order to avoid such inconvenience, in the first example embodiment, the traveling controller 13B is configured or programmed such that the respective orientations of the four drive wheels 2 are different from each other when the vehicle body 1 is stopped.

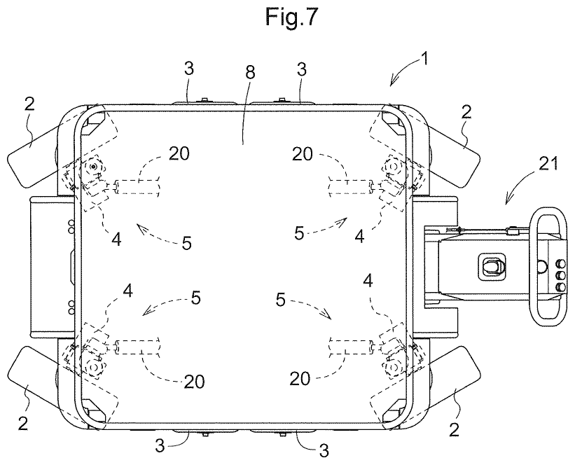

Specifically, as illustrated in FIG. 7, the orientation of each of the four drive wheels 2 is changed when the vehicle body 1 is stopped. That is, the traveling controller 13B in the controller C is configured or programmed such that all the orientations of the four drive wheels 2 are different from each other when the drive control of the drive wheels 2 is stopped.

In the example illustrated in FIG. 7, among the right and left drive wheels 2 located below the front portion of the vehicle body 1, the drive wheel 2 on the right side is turned counterclockwise and the drive wheel 2 on the left side is turned clockwise. Therefore, in each of the right and left drive wheels 2 located below the front portion of the vehicle body 1, the front portion of each of the right and left drive wheels 2 is located on the right and left center side of the vehicle body 1 with respect to the rear portion of each of the right and left drive wheels 2.

In addition, among the right and left drive wheels 2 located below the rear portion of the vehicle body 1, the drive wheel 2 on the right side is turned clockwise, and the drive wheel 2 on the left side is turned counterclockwise. Therefore, in each of the right and left drive wheels 2 located below the rear portion of the vehicle body 1, the rear portion of each of the right and left drive wheels 2 is located on the right and left center side of the vehicle body 1 with respect to the front portion of each of the right and left drive wheels 2.

Each orientation of the four drive wheels 2 is changed by the contraction operation of the turning cylinder 20. A cap-side end portion of the turning cylinder 20 is located on the front and rear center side of the vehicle body 1 with respect to the rod-side end portion of the turning cylinder 20. From this, when the drive control of the drive wheel 2 is stopped, the traveling controller 13B controls the respective four turning cylinders 20 to operate on the contraction side from the neutral stroke position.

By this method, the traveling controller 13B of the controller C is configured or programmed such that the respective orientations of the four drive wheels 2 are different from each other to make an end portion of the drive wheel 2 on a side located on the outer side in the front and rear with respect to the vehicle body 1 is located closer to the right and left center side of the vehicle body 1 than an end portion of the drive wheel 2 on a side located on the inner side in the front and rear with respect to the vehicle body 1.

As described above, the traveling controller 13B in the controller C is configured or programmed such that the respective orientations of the drive wheel 2 located on one of the right and left sides, and the drive wheel 2 located on the other of the right and left sides are different from each other to make the orientations opposite to each other with respect to the neutral orientation in which the vehicle body 1 is caused to move straight or substantially straight when the drive control of the drive wheels 2 is stopped. In addition, the traveling controller 13B in the controller C is configured or programmed such that the respective orientations of the drive wheel 2 located on one of the front and rear sides, and the drive wheel 2 located on the other of the front and rear sides are different from each other in the front and rear drive wheels 2 in each of one of the right and left sides and the other of the right and left sides, when the drive control of the drive wheels 2 is stopped.

From this, each of the four drive wheels 2 interacts a force with each other in directions different from the rotation directions, and receives a reaction force in a lateral skidding direction from the ground. That is, when the four drive wheels 2 are about to roll, friction occurs between each of the drive wheels 2 and the ground. As a result, each of the four drive wheels 2 does not rotate. Accordingly, for example, even in a case where the work vehicle is stopped for a long period of time on the inclined land, the stop position of the work vehicle is maintained. In addition, in a case where the vehicle body 1 performs neutral turning, the traveling controller 13B is able to quickly change the orientation of each of the four drive wheels 2 to an orientation along a tangential direction on the same arc of a circle having the center of the vehicle body 1 as a circle center.

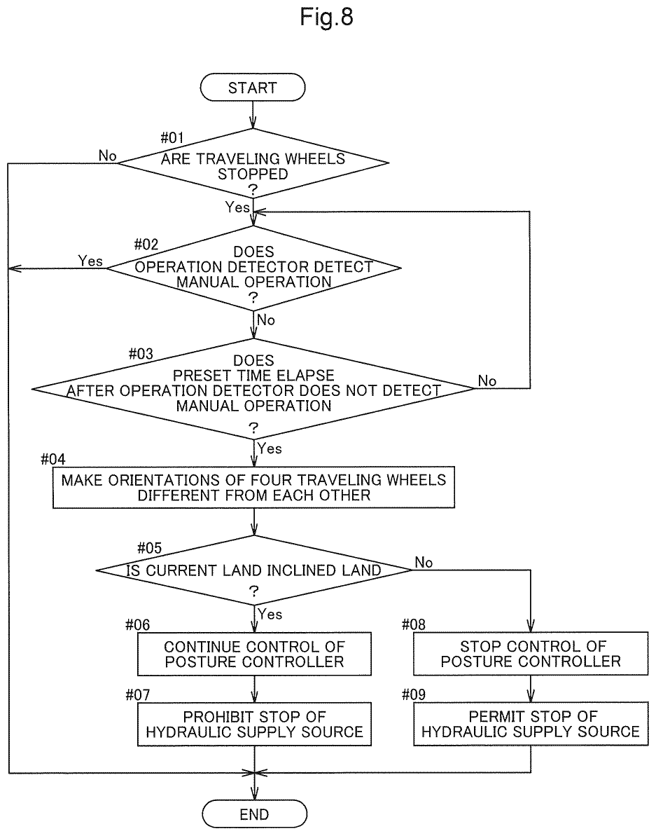

Control when the vehicle body 1 is stopped will be described based on a flowchart of FIG. 8. First, the ECU 13 determines whether the four drive wheels 2 are stopped (step #01). In a case where the four drive wheels 2 are stopped (Yes in step #01), the ECU 13 determines whether the operation detector 22 detects the manual operation from the drive operation interface 21 or the remote control device RC (step #02). When the operation detector 22 does not detect the manual operation (No in step #02), the ECU 13 counts a timer and determines whether a preset time elapses after the operation detector 22 does not detect the manual operation (step #03). The determination of step #03 is repeated until the count time of the timer elapses the preset time. Then, when the count time of the timer elapses the preset time (Yes in step #03), the traveling controller 13B is configured or programmed such that the respective orientations of the four drive wheels 2 are different from each other (step #04). That is, the traveling controller 13B of the controller C is configured or programmed such that the respective orientations of one of the right and left drive wheels 2 and the other of the right and left drive wheels 2 are different from each other when the preset time elapses after the operation detector 22 does not detect the manual operation.

When the processing of step #04 is completed, the ECU 13 determines whether a current land of the vehicle body 1 is the inclined land based on the detection information of the inclination sensor 33 (step #05). Specifically, the ECU 13 determines whether the inclination angle of the ground calculated by the inclination angle calculator 13C is equal to or greater than a preset set inclination angle. When the inclination angle of the ground is equal to or greater than the set inclination angle, the ECU 13 determines that the current land of the vehicle body 1 is the inclined land. In addition, when the inclination angle of the ground less than the set inclination angle, the ECU 13 determines that the current land of the vehicle body 1 is a flat land.

When the current land of the vehicle body 1 is the inclined land (Yes in step #05), the ECU 13 continues the control of the posture controller 13A (step #06) and prohibits the drive stop of the hydraulic supply source 9 (step #07). When the control of the posture controller 13A is stopped on the inclined land, the hydraulic control valve 12 for the first hydraulic cylinder 6 and the second hydraulic cylinder 7 is closed, and the stroke positions of the first hydraulic cylinder 6 and the second hydraulic cylinder 7 are maintained. Therefore, immediately after the stop of the control of the posture controller 13A, the horizontal state of the loading portion 8 is maintained. However, the hydraulic fluid inside each of the first hydraulic cylinder 6 and the second hydraulic cylinder 7 leaks from the hydraulic control valve 12 with the passage of time. In this case, the folding link mechanism 5 is gradually lowered due to the self-weight of the loading portion 8, and the loading portion 8 is gradually inclined along the inclined surface, and the horizontal state of the loading portion 8 is not maintained. In order to avoid such inconvenience, in a case where the current land of the vehicle body 1 is the inclined land, the control of the posture controller 13A is continued, and the drive of the hydraulic supply source 9 is also continued. That is, the posture controller 13A of the controller C is configured or programmed such that the operation of each of the first hydraulic cylinder 6 and the second hydraulic cylinder 7 is continuously controlled in a case where the ground is inclined by equal to or greater than the set inclination angle while the four drive wheels 2 are stopped. Accordingly, even in a case where the drive wheel 2 is stopped on the inclined land, the horizontal state of the loading portion 8 is maintained.

When the current land of the vehicle body 1 is not the inclined land (No in step #05), the current land of the vehicle body 1 is a flat land. Therefore, the ECU 13 stops the control of the posture controller 13A (step #08) and permits the drive stop of the hydraulic supply source 9 (step #09). As described above, the hydraulic fluid inside each of the first hydraulic cylinder 6 and the second hydraulic cylinder 7 leaks from the hydraulic control valve 12 with the passage of time. Even in this case, since the land is flat, each of the plurality of folding link mechanisms 5 is lowered substantially equally, and the horizontal state of the loading portion 8 is maintained. Therefore, when the current land of the vehicle body 1 is the flat land, the stop of the control of the posture controller 13A and the drive stop of the hydraulic supply source 9 are allowed. Accordingly, it is possible to reduce a running cost as compared with a configuration in which the posture controller 13A of the controller C continuously controls the operation of the support mechanism A on the flat land. That is, the posture controller 13A of the controller C is configured or programmed such that the operation of each of the first hydraulic cylinder 6 and the second hydraulic cylinder 7 is not controlled in a case where the ground is inclined within a range of the set inclination angle while the four drive wheels 2 are stopped.

As described above, the controller C is configured or programmed such that the operation of the support mechanism A is not controlled, and is configured or programmed such that the drive stop of the hydraulic supply source 9 is permitted in a case where the ground is inclined within the range of the preset set inclination angle while the four drive wheels 2 are stopped. On the other hand, the controller C is configured or programmed such that the operation of the support mechanism A is continuously controlled, and is configured or programmed such that the drive stop of the hydraulic supply source 9 is prohibited in a case where the ground is inclined by equal to or greater than the set inclination angle while the four drive wheels 2 are stopped.

The above is the first example embodiment. Hereinafter, a second example embodiment in which the present invention is exemplified will be described with reference to FIGS. 9 to 16.

### Second Example Embodiment

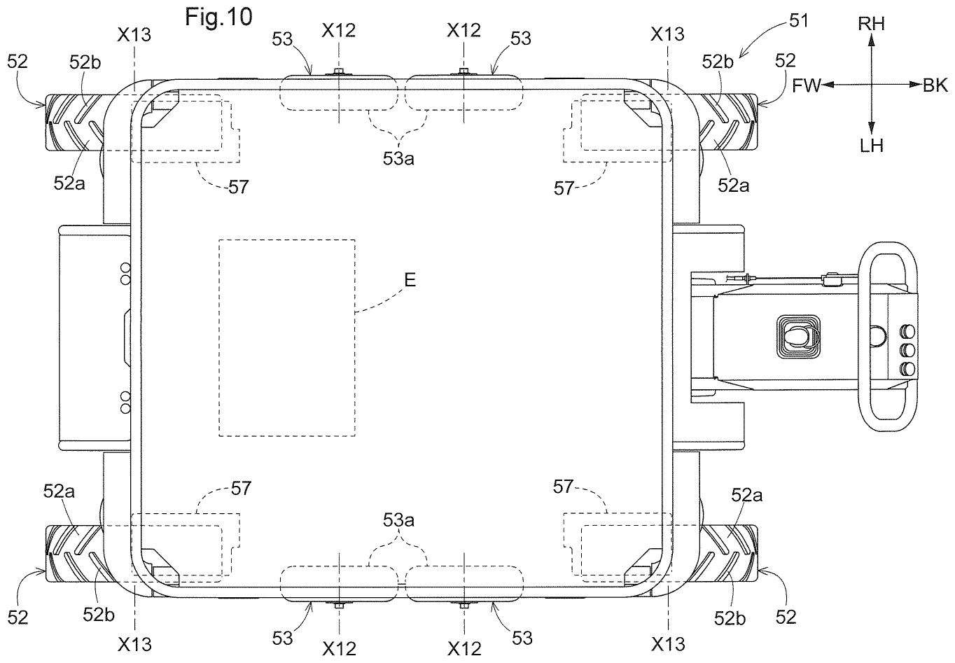

FIGS. 9 and 10 illustrate a work vehicle. As illustrated in FIGS. 9 and 10, the work vehicle is a work vehicle that is able to travel on an irregular land (a portion having a step or unevenness). The work vehicle includes a vehicle body 51 (vehicle main body), a plurality of (for example, four in the second example embodiment) drive wheels 52 (traveling wheels), a plurality of (for example, four in the second example embodiment) auxiliary wheels 53, a plurality of (for example, four in the second example embodiment) support legs 54, an engine E, a hydraulic pump (not illustrated), and a plurality of (for example, four in the second example embodiment) hydraulic motors M. A load is able to be placed on an upper surface of the vehicle body 51.

The engine E is provided below the vehicle body 51. The hydraulic pump pumps the hydraulic fluid to the hydraulic motor M, a first hydraulic cylinder CY1, a second hydraulic cylinder CY2, and a third hydraulic cylinder CY3, which will be described later in detail. The hydraulic pump is driven by the engine E.

The four drive wheels 52 include a drive wheel 52 on the left front side, a drive wheel 52 on the right front side, a drive wheel 52 on the left rear side, and a drive wheel 52 on the right rear side. The four auxiliary wheels 53 include an auxiliary wheel 53 on the left front side, an auxiliary wheel 53 on the right front side, an auxiliary wheel 53 on the left rear side, and an auxiliary wheel 53 on the right rear side.

The support leg 54 supports the drive wheel 52 and the auxiliary wheel 53. The four support legs 54 include a support leg 54 on the left front side, a support leg 54 on the right front side, a support leg 54 on the left rear side, and a support leg 54 on the right rear side. The support leg 54 on the left front side supports the drive wheel 52 on the left front side and the auxiliary wheel 53 on the left front side. The support leg 54 on the right front side supports the drive wheel 52 on the right front side and the auxiliary wheel 53 on the right front side. The support leg 54 on the left rear side supports the drive wheel 52 on the left rear side and the auxiliary wheel 53 on the left rear side. The support leg 54 on the right rear side supports the drive wheel 52 on the right rear side and the auxiliary wheel 53 on the right rear side.

The support leg 54 on the left front side is connected to a left side portion in a front portion of the vehicle body 51. The support leg 54 on the right front side is connected to a right side portion in the front portion of the vehicle body 51. The support leg 54 on the left rear side is connected to a left side portion in a rear portion of the vehicle body 51. The support leg 54 on the right rear side is connected to a right side portion of the rear portion of the vehicle body 51.

The support leg 54 is what is called a folding link mechanism and is configured to be refracted (extend and contract). The support leg 54 includes a first link 55, a second link 56, a first hydraulic cylinder CY1, a second hydraulic cylinder CY2, and a third hydraulic cylinder CY3. The first hydraulic cylinder CY1, the second hydraulic cylinder CY2, and the third hydraulic cylinder CY3 are driven to be extended and/or contracted by the hydraulic fluid from the hydraulic pump.

The first link 55 is swingably connected to the vehicle body 51 around a swing axis center X11 extending along a vehicle body right-left direction. The second link 56 is swingably connected to an end portion of the first link 55 on a side opposite to the vehicle body 51 around a swing axis center X12 extending along the vehicle body right-left direction.

The first hydraulic cylinder CY1 swing-drives the first link 55 around the swing axis center X11. The first hydraulic cylinder CY1 is provided between the vehicle body 51 and the first link 55. The first hydraulic cylinder CY1 extends and/or contracts, and thus, the first link 55 is swing-driven around the swing axis center X11.

The second hydraulic cylinder CY2 swing-drives the second link 56 around the swing axis center X12. The second hydraulic cylinder CY2 is provided between the first link 55 and the second link 56. The second hydraulic cylinder CY2 extends and/or contracts, and thus, the second link 56 is swing-driven around the swing axis center X12.

The drive wheels 52 cause the vehicle body 51 to travel. The drive wheel 52 is rotatable around a rotation axis center X13 extending along the vehicle body right-left direction. The drive wheel 52 is rotationally driven by the hydraulic motor M. The hydraulic motor M is rotationally driven by the hydraulic fluid from the hydraulic pump. The drive wheel 52 is operated to steer around a steering axis center Z1. The third hydraulic cylinder CY3 steering-drives the drive wheel 52 around the steering axis center Z1. The drive wheel 52 is supported at an end portion of the second link 56 on a side opposite to the swing axis center X12. A support portion 56a that supports the drive wheel 52 is provided at an end portion of the second link 56 on a side opposite to the swing axis center X12.

The auxiliary wheel 53 assists the traveling of the vehicle body 51. The auxiliary wheel 53 is rotatable around a rotation axis center (the same as the swing axis center X12) extending along the vehicle body right-left direction. The auxiliary wheel 53 extends outward in the lateral direction of the support leg 54 in the vehicle body right-left direction.

The four drive wheels 52 are each covered from above by a mudguard 57. That is, the work vehicle includes a plurality (four in the second example embodiment) of mudguards 57 that covers the respective four drive wheels 52 from above. The four mudguards 57 include a mudguard 57 on the left front side, a mudguard 57 on the right front side, a mudguard 57 on the left rear side, and a mudguard 57 on the right rear side. The mudguard 57 on the left front side covers the drive wheel 52 on the left front side from above. The mudguard 57 on the right front side covers the drive wheel 52 on the right front side from above. The mudguard 57 on the left rear side covers the drive wheel 52 on the left rear side from above. The mudguard 57 on the right rear side covers the drive wheel 52 on the right rear side from above.

The mudguard 57 extends along an outer peripheral shape of the drive wheel 52. Specifically, the mudguard 57 may have an arc shape or a substantially arc shape in a side view. The mudguard 57 is above the rotation axis center X13 of the drive wheel 52. The mudguards 57 on the front side and the mudguards 57 on the rear side are front-rear symmetrical. Specifically, the mudguards 57 on the front side are provided on a vehicle body inner side (rear side) with respect to the rotation axis center X13 of the drive wheels 52 on the front side in the vehicle body front-rear direction, and the mudguards 57 on the rear side are provided on a vehicle body inner side (front side) with respect to the rotation axis center X13 of the drive wheels 52 on the rear side in the vehicle body front-rear direction.

The mudguard 57 is supported by the support leg 54. Specifically, the mudguard 57 is supported by the second link 56. That is, the mudguard 57 is integrated with the second link 56 of the support leg 54. A portion of the second link 56 to which the mudguard 57 is attached has a shape (an arc shape or a substantially arc shape) that extends along the second link 56 in a side view. A gap G is present between the drive wheel 52 and the mudguard 57.

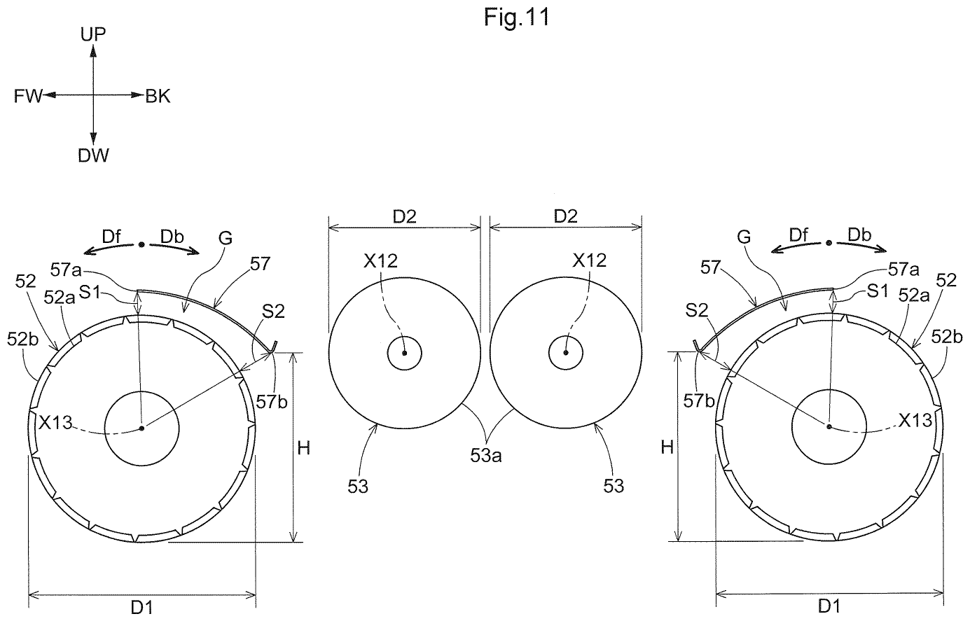

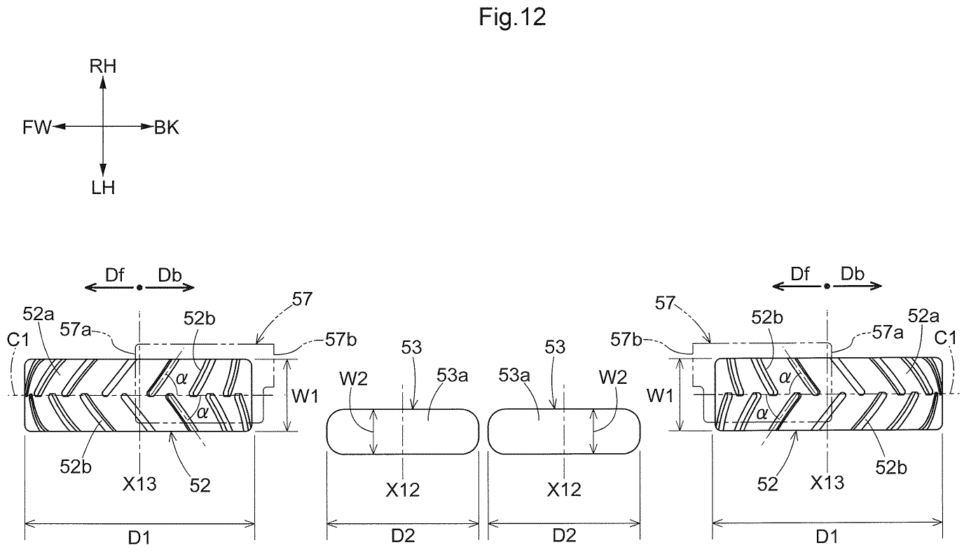

In FIGS. 11 and 12, an outer diameter D1 of the drive wheel 52, an outer diameter D2 of the auxiliary wheel 53, a rotation direction Df of the drive wheel 52 during forward movement of the work vehicle, a rotation direction Db of the drive wheel 52 during backward movement of the work vehicle, an outer end 57a of the mudguard 57 on a vehicle body outer side in the vehicle body front-rear direction, and an inner end 57b of the mudguard 57 on the vehicle body inner side in the vehicle body front-rear direction are denoted. In the mudguards 57 on the front side (the left front side and the right front side), the outer end 57a is a front end, and the inner end 57b is a rear end. In addition, in the mudguards 57 on the rear side (the left rear side and the right rear side), the outer end 57a is a rear end, and the inner end 57b is a front end.

In FIG. 11, an interval (first interval S1) between the outer end 57a and the outer periphery of the drive wheel 52 on a straight line connecting the outer end 57a and the rotation axis center X13 of the drive wheel 52, an interval (second interval S2) between the inner end 57b and the outer periphery of the drive wheel 52 on a straight line connecting the inner end 57b and the rotation axis center X13 of the drive wheel 52, and a height H from the lower end of the drive wheel 52 to the inner end 57b are denoted. In FIG. 12, a width of the drive wheel 52 is denoted by W1, and a width of the auxiliary wheel 53 is denoted by W2.

As illustrated in FIGS. 11 and 12, the outer diameter D2 of the auxiliary wheel 53 is smaller than the outer diameter D1 of the drive wheel 52. In other words, the outer diameter D1 of the drive wheel 52 is larger than the outer diameter D2 of the auxiliary wheel 53. The width W2 of the auxiliary wheel 53 is smaller than the width W1 of the drive wheel 52. In other words, the width W1 of the drive wheel 52 is larger than the width W2 of the auxiliary wheel 53.

The outer end 57a is located at the same or substantially the same position as the rotation axis center X13 of the drive wheel 52 in the vehicle body front-rear direction. The inner end 57b is located above the rotation axis center X13 of the drive wheel 52 and is located on the vehicle body inner side with respect to the end of the drive wheel 52 on the vehicle body inner side in the vehicle body front-rear direction. The height H is higher than a height from the lower end of the drive wheel 52 to the rotation axis center X13 of the drive wheel 52. The second interval S2 is larger than the first interval S1. That is, the gap G gradually increases from the vehicle body outer side toward the vehicle body inner side in the vehicle body front-rear direction.

Lugs 52b are provided on a tread portion 52a of the drive wheel 52. A tread portion 53a of the auxiliary wheel 53 has a different shape than that of the tread portion 52a of the drive wheel 52. Specifically, the lugs are not provided on the tread portion 53a of the auxiliary wheel 53. That is, the lugs 52b are provided only in the tread portion 52a of the drive wheel 52 among the tread portion 52a of the drive wheel 52 and the tread portion 53a of the auxiliary wheel 53.

In FIG. 12, an inclination angle of the lug 52b with respect to a width center C1 of the drive wheel 52 is denoted by α. The lugs 52b are inclined with respect to a circumferential direction of the drive wheel 52. In FIG. 12, the inclination angle with respect to the width center C1 of the drive wheel 52 is a even for the lug 52b other than the lug 52b at which the inclination angle α is illustrated.

As illustrated in FIG. 12, the lugs 52b include lugs 52b located on the vehicle body outer side (hereinafter, simply referred to as the “vehicle body outer side”) in the vehicle body right-left direction with respect to the width center C1 of the drive wheel 52, and lugs 52b located on the vehicle body inner side (hereinafter, simply referred to as the “vehicle body inner side”) in the vehicle body right-left direction with respect to the width center C1 of the drive wheel 52. The lugs 52b located on the vehicle body outer side and the lugs 52b located the vehicle body inner side are misaligned in the circumferential direction of the drive wheel 52. The tread portion 52a of the drive wheels 52 on the front side and the tread portion 52a of the drive wheels 52 on the rear side are configured to be front-rear symmetrical. Specifically, the lugs 52b in the drive wheels 52 on the front side and the lugs 52b in the drive wheels 52 on the rear side are arranged front-rear symmetrically. Specifically, the lugs 52b in the drive wheels 52 on the front side and the lugs 52b in the drive wheels 52 on the rear side are arranged as follows.

The lugs 52b in the drive wheels 52 on the front side are inclined to be closer to the width center C1 of the drive wheel 52 as the downstream side in the rotation direction of the rotation direction Df of the drive wheel 52 when the work vehicle moves forward. In other words, the lugs 52b in the drive wheels 52 on the front side are inclined to be farther away from the width center C1 of the drive wheel 52 as the downstream side in the rotation direction of the rotation direction Db of the drive wheel 52 when the work vehicle moves backward.

The lugs 52b in the drive wheels 52 on the rear side are inclined to be closer to the width center C1 of the drive wheel 52 as the downstream side in the rotation direction of the rotation direction Db of the drive wheel 52 when the work vehicle moves backward. In other words, the lugs 52b in the drive wheels 52 on the rear side are inclined to be farther away from the width center C1 of the drive wheel 52 as the downstream side in the rotation direction of the rotation direction Df of the drive wheel 52 when the work vehicle moves forward.

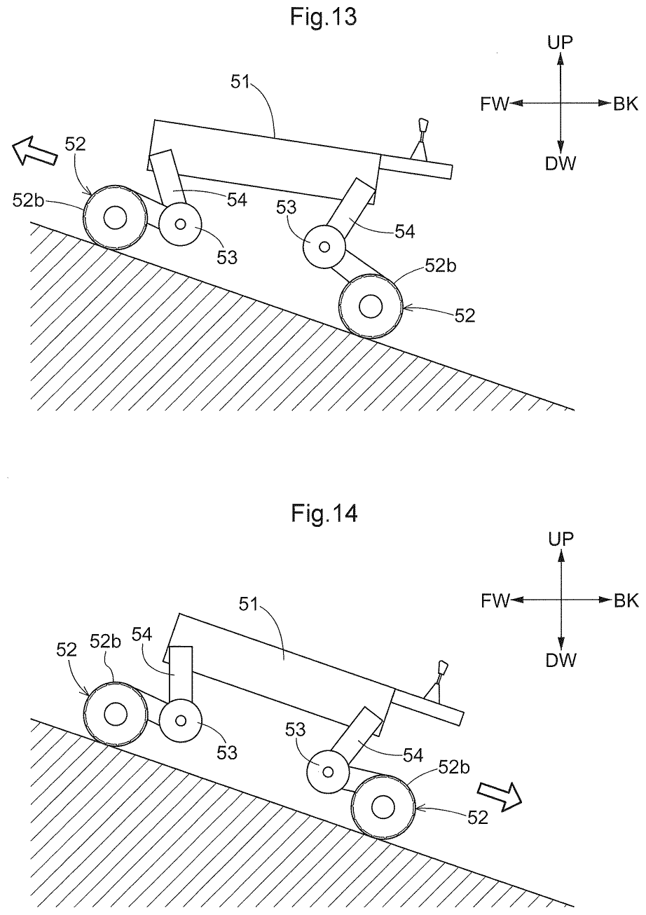

With such a configuration, as illustrated in FIG. 13, in a case where the work vehicle moves forward on an uphill slope, the load is able to be concentrated on the drive wheel 52 on the left front side and the drive wheel 52 on the right front side, and a grip force by the drive wheel 52 on the left front side and the drive wheel 52 on the right front side is able to be improved. In addition, as illustrated in FIG. 14, in a case where the work vehicle moves backward on a downhill slope, the load is able to be concentrated on the drive wheel 52 on the left rear side and the drive wheel 52 on the right rear side, and a grip force by the drive wheel 52 on the left rear side and the drive wheel 52 on the right rear side is able to be improved.

In the second example embodiment, as described above, the tread portions 52a of the drive wheels 52 on the front side and the tread portion 52a of the drive wheels 52 on the rear side are configured to be front-rear symmetrical, and the mudguards 57 on the front side and the mudguards 57 on the rear side are front-rear symmetrical. Accordingly, the work vehicle is able to be used as the forward movement direction in any direction of the arrow “FW” and the arrow “BK”.

### Other Example Embodiments

The present invention is not limited to the configurations exemplified in the first example embodiment and the second example embodiment. Hereinafter, representative other example embodiments of the present invention will be exemplified.

(1) In the first example embodiment, when the controller C stops the drive control of the drive wheels 2, the controller C changes the orientations of all four drive wheels 2 separately. The present invention is not limited to this example embodiment, and for example, the controller C may also be configured or programmed to change the respective orientations of one to three among the four drive wheels 2 separately. For example, the controller C may also be configured or programmed such that the respective orientations of two drive wheels 2 (the first drive wheel and the second drive wheel) located on the lower side among the four drive wheels 2 are different from each other based on the inclination state of the vehicle body 1. For example, the controller C may also be configured or programmed such that the respective orientations of the drive wheel 2 (first drive wheel) located on the lower side on one of the front and rear sides on one of the right and left sides and the drive wheel 2 (second drive wheel) located on the lower side on one of the front and rear sides on the other of the right and left sides among the four drive wheels 2 are different from each other based on the inclination state of the vehicle body 1.

(2) The support mechanism A illustrated in the first example embodiment may also be a mechanism including one link (support leg) or three or more links. For example, the support mechanism A may include an electric actuator as a device that changes the posture. The support leg 54 illustrated in the second example embodiment may also include an electric actuator as a device that changes the posture.

(3) The drive wheel 2 illustrated in the first example embodiment may also be driven by an electric motor instead of the hydraulic motor 4, or may also be driven by the engine 9a or the like via a drive mechanism. The drive wheel 52 illustrated in the second example embodiment may also be driven by an electric motor or may also be driven by an engine or the like via a drive mechanism.

(4) The drive wheel 2 illustrated in the first example embodiment may also be turning-driven by a hydraulic motor, an electric motor, or the like instead of the turning cylinder 20. The drive wheel 52 illustrated in the second example embodiment may also be turning-driven by a hydraulic motor, an electric motor, or the like instead of the third hydraulic cylinder CY3.

(5) In the first example embodiment, the drive operation interface 21 is provided behind the loading portion 8 in the vehicle body 1. For example, a configuration may also be adopted in which the drive operation interface 21 is not provided. In this case, the operation detector 22 may also be configured to receive only the wireless signal from the remote control device RC of the wireless communication method. Alternatively, the operation detector 22 may also be configured to receive only the signal from the drive operation interface 21.

(6) The configuration may also be adopted in which the support mechanism A of the first example embodiment is not provided. In this case, the loading portion 8 is not maintained in the horizontal posture on the inclined land, but as long as a configuration is provided in which the orientations of the first drive wheel and the second drive wheel are different from each other on the inclined land, a concern that the work vehicle gradually descends the inclined land due to the self-weight of the work vehicle is avoided.

(7) In the first example embodiment, the controller C is configured or programmed such that the respective orientations of the first drive wheel and the second drive wheel are different from each other when a preset time elapses from a time when the operation detector 22 does not detect the manual operation. The present invention is not limited to this example embodiment, and for example, the controller C may also be configured or programmed to immediately make the respective orientations of the first drive wheel and the second drive wheel different from each other when the operation detector 22 does not detect the manual operation.

(8) In the first example embodiment, the support mechanism A includes the folding link mechanism 5 (support leg). The present invention is not limited to this example embodiment, and for example, a configuration may also be adopted in which the support mechanism A includes a slide mechanism that is able to be lifted and lowered up and down instead of the folding link mechanism 5.

(9) In the first example embodiment, the inclination sensor 33 is provided as the inclination detector. The present invention is not limited to this example embodiment, and for example, the inclination detector may also be a mechanical pendulum type sensor or a magnetic sensor.

(10) In the first example embodiment, the ECU 13 determines whether the inclination angle of the ground calculated by the inclination angle calculator 13C is equal to or greater than a preset set inclination angle. Then, when the inclination angle of the ground is equal to or greater than the set inclination angle, the ECU 13 determines that the current land of the vehicle body 1 is the inclined land. The present invention is not limited to this example embodiment, and “equal to or greater than the set inclination angle” means an inclination angle greater than the set inclination angle without including the set inclination angle. The configuration may also be adopted in which the ECU 13 does not determine that the current land of the vehicle body 1 is the inclined land and determines that the current land of the vehicle body 1 is the flat land in a case where the inclination angle of the ground is the set inclination angle.

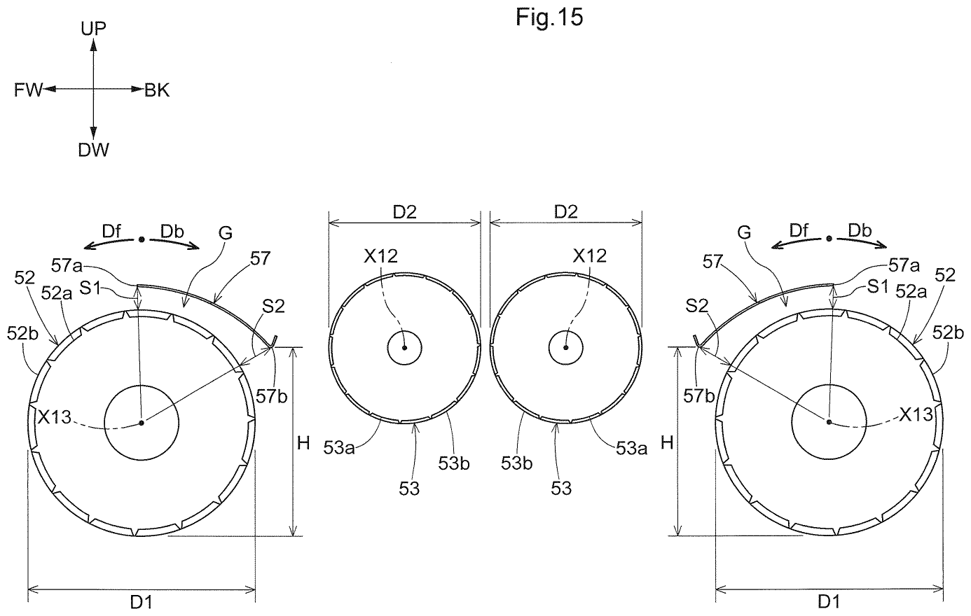

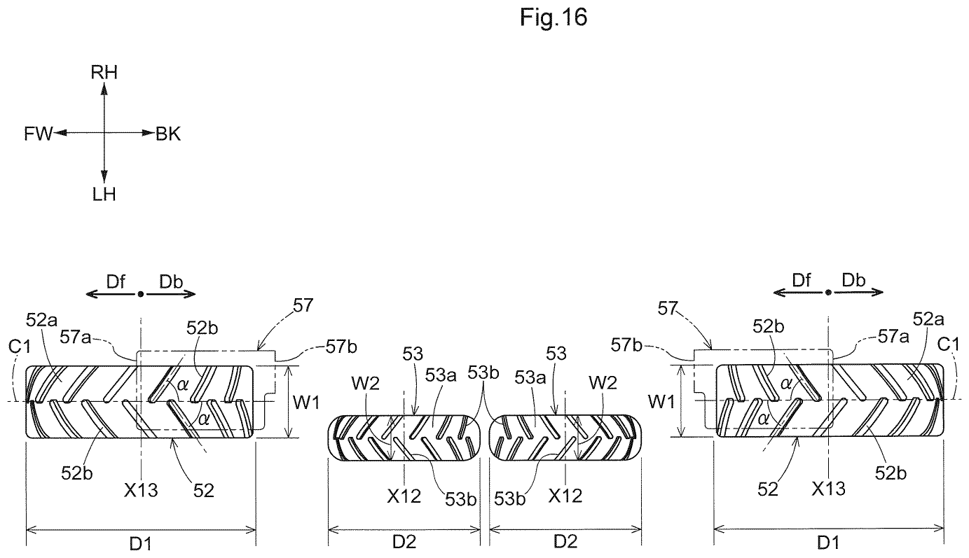

(11) In the second example embodiment, the lugs are not provided on the tread portion 53a of the auxiliary wheel 53. That is, the lugs 52b are provided only in the tread portion 52a of the drive wheel 52 among the tread portion 52a of the drive wheel 52 and the tread portion 53a of the auxiliary wheel 53. As illustrated in FIGS. 15 and 16, the lugs 53b may be provided on the tread portion 53a of the auxiliary wheel 53. That is, the lugs 52b and 53b may also be provided on the tread portion 52a of the drive wheel 52 and the tread portion 53a of the auxiliary wheel 53, respectively.

A height of the lug 53b of the auxiliary wheel 53 is lower than a height of the lug 52b of the drive wheel 52. That is, the tread portion 53a of the auxiliary wheel 53 has a different shape than that of the tread portion 52a of the drive wheel 52. The lugs 53b in the auxiliary wheels 53 on the front side and the lugs 52b in the auxiliary wheels 53 on the rear side are arranged front-rear symmetrically.

(12) In the second example embodiment, the lugs 52b in the drive wheels 52 on the front side and the lugs 52b in the drive wheels 52 on the rear side are arranged front-rear symmetrically. The lugs 52b in the drive wheels 52 on the front side and the lugs 52b in the drive wheels 52 on the rear side may be arranged front-rear asymmetrically.

For example, in a case where the work vehicle is used with the direction of the arrow “FW” as the forward movement direction and the direction of the arrow “BK” as the backward movement direction, the orientation of the lugs 52b in the drive wheels 52 on the rear side may be the same as the orientation of the lugs 52b in the drive wheels 52 on the front side, and the mudguards 57 on the rear side may be provided on the vehicle body outer side (rear side) with respect to the rotation axis center X13 of the drive wheels 52 on the rear side in the vehicle body front-rear direction. In addition, in a case where the work vehicle is used with the direction of the arrow “BK” as the forward movement direction and the direction of the arrow “FW” as the backward movement direction, the orientation of the lugs 52b on the drive wheels 52 on the front side may be the same as the orientation of the lugs 52b on the drive wheels 52 on the rear side, and the mudguards 57 on the front side may be provided on the vehicle body outer side (front side) with respect to the rotation axis center X13 of the drive wheels 52 on the front side in the vehicle body front-rear direction.

(13) In the second example embodiment, the drive wheel 52 is inclined at the inclination angle α. The arrangement of the drive wheel 52 is not limited to the above-described example embodiment.

(14) In the second example embodiment, the outer diameter D2 of the auxiliary wheel 53 is smaller than the outer diameter D1 of the drive wheel 52. The outer diameter D2 of the auxiliary wheel 53 may be the same as the outer diameter D1 of the drive wheel 52.

(15) In the second example embodiment, the mudguard 57 extends along the outer peripheral shape of the drive wheel 52. The mudguard 57 may not extend along the outer peripheral shape of the drive wheel 52.

(16) In the second example embodiment, the mudguard 57 is above the rotation axis center X13 of the drive wheel 52. The mudguard 57 may not be above the rotation axis center X13 of the drive wheel 52. That is, a portion of the mudguard 57 may be located below the rotation axis center X13 of the drive wheel 52.

(17) In the second example embodiment, the mudguard 57 is supported by the support leg 54. The mudguard 57 may be supported by a structure different from the support leg 54.

(18) In the first example embodiment and the second example embodiment, the work vehicle includes the four drive wheels 2 and 52. The number of the drive wheels 2 is not limited to four, and may also be two, three, or five or more. The number of the drive wheels 52 is not limited to four, and may also be two, three, or five or more.

(19) In the first example embodiment and the second example embodiment, the work vehicle includes the four auxiliary wheels 3 and 53. The number of the auxiliary wheels 3 is not limited to four and may also be two, three, or five or more. The number of the auxiliary wheels 53 is not limited to four, and may also be two, three, or five or more.

(20) In the first example embodiment, the work vehicle includes the four folding link mechanisms 5 (support legs). The number of the folding link mechanisms 5 is not limited to four, and may also be two, three, or five or more. In the second example embodiment, the work vehicle includes the four support legs 54. The number of the support legs 54 is not limited to four and may also be two, three, or five or more.

The configurations disclosed in the above-described example embodiments (including the first example embodiment, the second example embodiment, and other separate example embodiments thereof, the same applies hereinafter) are able to be applied in combination with the configurations disclosed in other example embodiments as long as there is no contradiction. In addition, the example embodiments disclosed in the present specification are examples, and the example embodiments of the present invention are not limited to these, and it is possible to appropriately modify the example embodiments of the present invention within a range or scope of the present invention.

Example embodiments of the present invention are applicable to work vehicles.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle, comprising:
a vehicle body including a loading portion that is able to load a load;
a plurality of drive wheels each located in front and rear on both right and left sides of the vehicle body, and configured to be steered separately;
a steering angle detector to detect respective orientations of the plurality of drive wheels; and
a controller configured or programmed to perform drive control to drive each of the plurality of drive wheels and control to change the respective orientations of the plurality of drive wheels separately; wherein
the controller is configured or programmed such that the respective orientations of a first drive wheel located on one of right and left sides of the vehicle body among the plurality of drive wheels and a second drive wheel located on the other of the right and left sides of the vehicle body among the plurality of drive wheels are different from each other when the drive control is stopped.

2. The work vehicle according to claim 1, wherein the controller is configured or programmed such that the respective orientations of the first drive wheel and the second drive wheel are different from each other to make the respective orientations opposite to each other with respect to a neutral orientation in which the vehicle body is caused to move straight or substantially straight when the drive control is stopped.

3. The work vehicle according to claim 1, wherein the controller is configured or programmed such that the orientations of all the plurality of drive wheels are different from each other when the drive control is stopped.

4. The work vehicle according to claim 1, further comprising:
an inclination detector to detect an inclination state of the vehicle body; wherein
the controller is configured or programmed such that the respective orientations of the first drive wheel located on a lower side in one of the right and left sides among the plurality of drive wheels and the second drive wheel located on a lower side on the other of the right and left sides among the plurality of drive wheels are different from each other based on the inclination state of the vehicle body.

5. The work vehicle according to claim 1, further comprising:
an operation detector to detect a manual operation with respect to the plurality of drive wheels; wherein
the controller is configured or programmed such that the respective orientations of the first drive wheel and the second drive wheel are different from each other when a preset time elapses from a time when the operation detector detects no manual operation.

6. The work vehicle according to claim 1, further comprising:
a support supported by the vehicle body to support the plurality of drive wheels to be positionally changeable with respect to the vehicle body;
a hydraulic motor to drive each of the plurality of drive wheels by using supply and discharge of hydraulic fluid as drive energy;
a control valve to change supply and discharge amounts of the hydraulic fluid with respect to the hydraulic motor; and
an inclination detector to detect an inclination state of the loading portion; wherein
the controller is configured or programmed to control an operation of the support such that the loading portion is in a horizontal posture based on the inclination state of the loading portion, and such that the drive control is stopped by closing the control valve to block the supply and discharge of the hydraulic fluid with respect to the hydraulic motor when the vehicle is stopped.

7. A work vehicle, comprising:
a vehicle body;
a plurality of drive wheels to cause the vehicle body to travel;
a plurality of auxiliary wheels to assist traveling of the vehicle body; and
a plurality of support legs connected to the vehicle body to support the drive wheels and the auxiliary wheels; wherein
lugs are provided on a tread portion of the drive wheel; and
a tread portion of the auxiliary wheel has a different shape than that of the tread portion of the drive wheel.

8. The work vehicle according to claim 7, wherein the lugs are provided only on the tread portion of the drive wheel in the tread portion of the drive wheel and the tread portion of the auxiliary wheel.

9. The work vehicle according to claim 7, wherein
the lugs are provided on the tread portion of the drive wheel and the tread portion of the auxiliary wheel, respectively; and
a height of the lug of the auxiliary wheel is lower than a height of the lug of the drive wheel.

10. The work vehicle according to claim 8, wherein
the plurality of drive wheels includes the drive wheels on a front side and the drive wheels on a rear side; and
the lugs in the drive wheels on the front side and the lugs in the drive wheels on the rear side are arranged front-rear symmetrically.

11. The work vehicle according to claim 7, wherein an outer diameter of the auxiliary wheel is smaller than an outer diameter of the drive wheel.

12. The work vehicle according to claim 7, further comprising:
a plurality of mudguards to cover each of the plurality of drive wheels from above; wherein
the mudguards extend along an outer peripheral shape of the drive wheels.

13. The work vehicle according to claim 12, wherein the mudguards are above rotation axis centers of the drive wheels.

14. The work vehicle according to claim 12, wherein
the drive wheels are operable to steer; and
the mudguards are supported by the support legs.
